(19) United States
(12) Patent Application Publication
(10) Pub. No.: US 2004/0162058 A1
(43) Pub. Date: Aug. 19, 2004

(54) Multi MVNO and service provider platform and management

(76) Inventor: Dorron Mottes, Caesarea (IL)

Correspondence Address: DORRON MOTTES, 11 LEMON St., P.O. Box 4562, CAESAREA, 38900, IL

(21) Appl. No.: 10/737,067

(22) Filed: Dec. 8, 2003

Related U.S. Application Data
(60) Provisional application No. 60/435,521, filed on Dec. 23, 2002.
(60) Provisional application No. 60/435,520, filed on Dec. 23, 2002.

(51) Int. Cl. H04M 1/66; H04M 1/68

(52) U.S. Cl. 455/411; 455/435.1; 455/432.1

(57) ABSTRACT

The present invention relates to a method and a wireless device and a system and an entity which enables an End User to use and or subscribe to several service providers and or Mobile Virtual Network Operators (MVNOs), the various End User profiles and or subscriptions will be managed by the system. Enabling End Users to develop rules for moving between various service providers and or various MVNOs.

### CROSS-REFERENCE TO RELATED APPLICATION

This application claims the benefit of U.S. Provisional Applications No. 60/435,521 filed Dec. 23, 2002, “Wireless device and platform and an entity which enable an end user to use and or subscribe to several virtual network operators and or mobile operators”, and No. 60/435,520 filed Dec. 23, 2002, “Payment platform and an entity enabling wireless payments with an interface to develop applications which will operate across various communication networks”, both applications are incorporated herein by reference.

The present invention relates to a method and a wireless device and a system and an entity which enables an End User to use and or subscribe to several service providers and or Mobile Virtual Network Operators (MVNOs), the various End User profiles and or subscriptions will be managed by the system. Enabling End Users to develop rules for moving between various service providers and or various MVNOs.

### BACKGROUND OF THE INVENTION

Currently, the communication market operators (i.e. mobile, wireline) provide and operate the communication network; on top of it they provide services and applications (i.e. voice mail, conference call), which are provided to their customers.

In order to continue growing the operators will need to focus and select to be either, a network operator or a service provider. The network operators will be large entities because there is an advantage to the size of the operator, enabling them to be more cost effective. This will lead to consolidation across international markets creating large international network providers. Service providers can be of various sizes depending on the market they are targeting. Because service providers will customize and localize their services, most of them will be small or medium size, and many of them won't have communication expertise.

The service providers' expertise and core competencies will be in one or several of the following fields: Service creation, content management, content creation, customer management, and marketing.

In order for the service providers to provide service they will need a communication platform, which will interface with the various communication networks (i.e. mobile network, Wireless LAN, Wireline network, Internet) and infrastructure from various network operators, and a platform on which they can develop and manage standard and new services.

Service providers are entities, which provide a service which is accessed via a network. The service provider can provide subscription and mobile services (i.e. MVNO, MNO); however, they can provide only a specific service or a set of services with no network and or subscription or mobile services (i.e. issuer of a credit card, games portal, application service provider).

Some of the service providers will provide communication services as A Mobile Virtual Network Operator (MVNO), a MVNO can be defined as an organization that offers mobile subscription and call services to customers but does not have an allocation of spectrum.

As this market evolves, customers would like to have service with several MVNOs and or service providers and will want to be able to easily switch between various service providers and or MVNOs with out carrying several wireless devices. This is similar to holding several payment cards (i.e. credit card, prepaid card, debit card, store card) with various benefits and using the payment card they want for each purchase; in this case, however, End Users would not want to carry several wireless devices. In addition, these payment cards can also be part of the services a customer selects to use on their wireless device. Today an End User, who uses a MVNO or a service provider for wireless service, can not use or needs a cumbersome process to use the same wireless device with an additional MVNO and or service provider.

It is an object of the present invention to provide a method and a wireless device and a system and an entity, which enables an End User to use the same wireless device and or selected wireless devices, with various MVNOs and or various service providers, and enabling the End User to easily switch between the service providers and MVNOs.

### SUMMARY OF THE INVENTION

It is an object of the present invention to provide a method and a wireless device and a system and an entity to enable an End User to use the same wireless device and or selected wireless devices with various MVNOs and or various service providers. The End User selects the service provider and or the MVNO they would like to use for each application and or service they would like to use. Once a service provider or a MVNO is selected it will be the one providing the services for this specific use in this specific moment. The End User can create default profiles for various types of service, for example all wireless purchases will be paid from the default credit card; all voice minutes are used from service provider X; voice mail service is used from service provider Y; and all calls after 17:00 to the wireless corporate number will be directed to the corporate voice mail, a service provided by the corporate service provider (service provider Z).

A MVNO Application Service Provider (MVNO ASP) will operate a MVNO Application Service Provider Platform (MVNO ASP Platform or System). This System enables End Users to do tasks such as, instantly change service providers and or MVNOs and enables them to manage their various profiles and service providers, including the ability to set default service providers for specific applications, adding new service providers and receive consolidated reports. End User can select any Service provider or MVNO that partnered with the MVNO ASP and add them to the list of optional service providers and MVNOs; and or select cases where a specific service provider or MVNO is the default provider. In some cases the service provider or MVNO will need to authorize the End User to join the service (i.e. a wireless credit card).

The MVNO user interface integrates with the MVNO ASP user interface creating an integrated user interface. An End User can access their preferences and default interfaces while using any MVNO interface. In addition, End Users can define additional menus and parts of the MVNO ASP user interface, which will always be part of the main portal view.

The MVNO ASP suppliers are the various communication network operators (i.e. mobile operators, WLAN operators, wireline operators, ISPs, cable operators). The MVNO ASP System will integrate and or communicate with its suppliers network and or systems, and will have agreements to buy and or rent capacity and or rent services and or rent systems from the network operators.

The MVNO ASP customers are various MVNOs and service providers, which market under their name, mobile subscription and or mobile services, which are based on the MVNO ASP virtual wireless network and services. The MVNO ASP provides MVNOs with access to the System and sells and or rents to them various network capacity and communication services, such as mobile minutes, bandwidth rental, content and service rent.

The System enables a MVNO to develop applications and services, and or provide mobile subscription and or services and or market services to their customers and potential customers, while working with one MVNO ASP System. The System provides an interface for the MVNOs to develop, manage and support the various applications and services. The interface hides the communication infrastructure and takes care of executing the communication related tasks, enabling the MVNO to focus on building the business logic, the applications and services.

The main advantages for the End Users to use the MVNO ASP and to use the MVNO ASP Platform are:

They can select several service providers and or MVNO to operate from one wireless device or selected wireless devices, enabling them to create the best package for them.

No need to use several wireless device;

One logon to all wireless systems and services;

Because of the open nature of the System many developers, other service providers and MVNOs and the MVNO ASP will develop many value added services on top of the System; MVNOs and service providers can offer these services to their companies too (most likely they will have to license rent or pay a fee for using these services and applications, however they will be available immediately with no need for additional development);

Enables MVNOs and service providers to develop cross-product and cross services promotions and develop creative pricing;

MVNOs and service providers do not need to develop partnerships and agreements with network operators enabling them to focus on their business and customers; and

Small to medium size entities can enter the MVNO and service provider market (They could not do that before because of the capital investment and lack of knowledge and resources); enabling their customers to use their service only when they use the niche service, while for other services and areas they can use other service providers with the same wireless device.

An End User will able to use several service providers from one device, for example to use a Supermarket MVNO, for discounts and special offers while in the Supermarket; and use a car rental MVNO to receive in car map direction and receive side road assistance. The End User can add additional MVNOs and service providers as needed.

This invention includes specific services and applications, which are based on the infrastructure invention, enabling Issuers of payment card, Acquirers and Processors to provide wireless payment services.

### BRIEF DESCRIPTION OF THE DRAWINGS

The present invention will be further understood and appreciated from the following detailed description taken in conjunction with the drawings in which:

FIG. 1 there is shown a block diagram illustration of one embodiment of the invention, in which a wireless device which includes an application is described.

In FIG. 2 there is shown a block diagram illustration of one embodiment of the invention, in which a MVNO ASP Profile Manager (Profile Manager) is described.

In FIG. 3 there is shown a block diagram illustration of one embodiment of the invention, of a MVNO ASP Platform.

In FIG. 4 there is shown an architecture diagram illustration of one embodiment of the invention, in which the MVNO ASP Payment Platform is part of an MVNO ASP operation, which includes switching capabilities.

In FIG. 5 there is shown an architecture diagram illustration of one embodiment of the invention, in which an End User uses several different service providers.

In FIG. 6 there is shown an architecture diagram illustration of one embodiment of the invention, in which an authentication process is described.

In FIG. 7 there is shown a flow chart of one embodiment of the invention, of a mobile user network registration and authentication process.

In FIG. 8 there is shown a flow chart of one embodiment of the invention, of an inbound voice call to a MVNO mobile user which their MVNO is hosted by a MVNO ASP, this example is based on a GSM network.

In FIG. 9 there is shown a flow chart of one embodiment of the invention, of an outbound voice call from a MVNO mobile user which their MVNO is hosted by a MVNO ASP, this example is based on a GSM network.

In FIG. 10 there is shown an architecture diagram illustration of one embodiment of the invention, in which a payment card application is described.

In FIG. 11 there is shown a flow chart diagram of one embodiment of the invention, in which an End User purchases goods via their wireless device.

In FIG. 12 there is shown a flow chart diagram of one embodiment of the invention, in which an End User selects the MVNO to use.

### DETAILED DESCRIPTION OF THE INVENTION

It is an object of the present invention to provide a wireless device and a method and a Platform to enable an End User to use the same wireless device and or selected wireless devices with various MVNOs and or various service providers. The End User selects the service provider and or the MVNO they would like to use for each application and or service they would like to use. Once a service provider or a MVNO is selected it will be the one providing the services for this specific use in this specific moment. The End User can create default profiles for various types of service, for example all wireless purchases will be paid from the default credit card; all voice minutes are used from service provider X; voice mail service is used from service provider Y; and all calls after 17:00 to the wireless corporate number will be directed to the corporate voice mail, a service provided by the corporate service provider (service provider Z).

A MVNO Application Service Provider (MVNO ASP) will operate a MVNO Application Service Provider Platform (MVNO ASP Platform or System). This System enables End Users to do tasks such as, instantly change service providers and or MVNOs and enables them to manage their various profiles and service providers, including the ability to set default service providers for specific applications, adding new service providers and receive consolidated reports. End User can select any Service provider or MVNO that partnered with the MVNO ASP and add them to the list of optional service providers and MVNOs; and or select cases where a specific service provider or MVNO is the default provider. In some cases the service provider or MVNO will need to authorize the End User to join the service (i.e. a wireless credit card).

End User wireless device registers to the MVNO ASP virtual network, based on the End User routing table, which is stored on the device. The routing table is a copy of the MVNO ASP master routing table, which defines to which network the wireless device should register in each area. In areas where there is more then one network, which is part of the MVNO ASP virtual network, the routing table can include additional parameters in order to select the network, parameters such as, time of the day, and type of device. The MVNO ASP master routing table will automatically update the End User local copy whenever there are changes in the master table.

The System enables End Users, which are registered to the network, to switch between MVNOs, which provide at least part of their service based on the MVNO ASP virtual wireless network, without the need to disconnect from the network and register to the network again. For example, the MVNO ASP Platform receives a request from an End User to change their service from one MVNO to another. The transfer is only “virtal” transfer (there is no need for physical switching), because both MVNOs are part of the MVNO ASP virtual wireless network.

The MVNO ASP manages the “virtual” transfer, it tracks events and logs the transfer so all events from this point and on should be attributed to the second MVNO; in addition, it manages the user interface update. The user interface includes items such as skins, ringtones, links, texts, graphics, and menus. If present, the End User device will use a cached copy of the new MVNO user interface, if needed, it will download part or the entire new MVNO user interface over the network. The MVNO user interface integrates with the MVNO ASP user interface creating an integrated End User interface.

An End User can access their preferences and default interfaces while using any MVNO interface. In addition, End Users can define additional menus and parts of the MVNO ASP user interface, which will always be part of the main portal view.

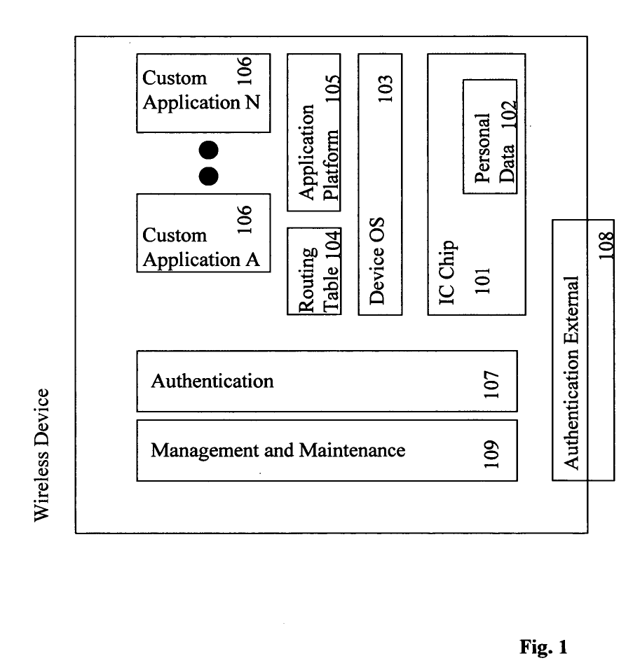

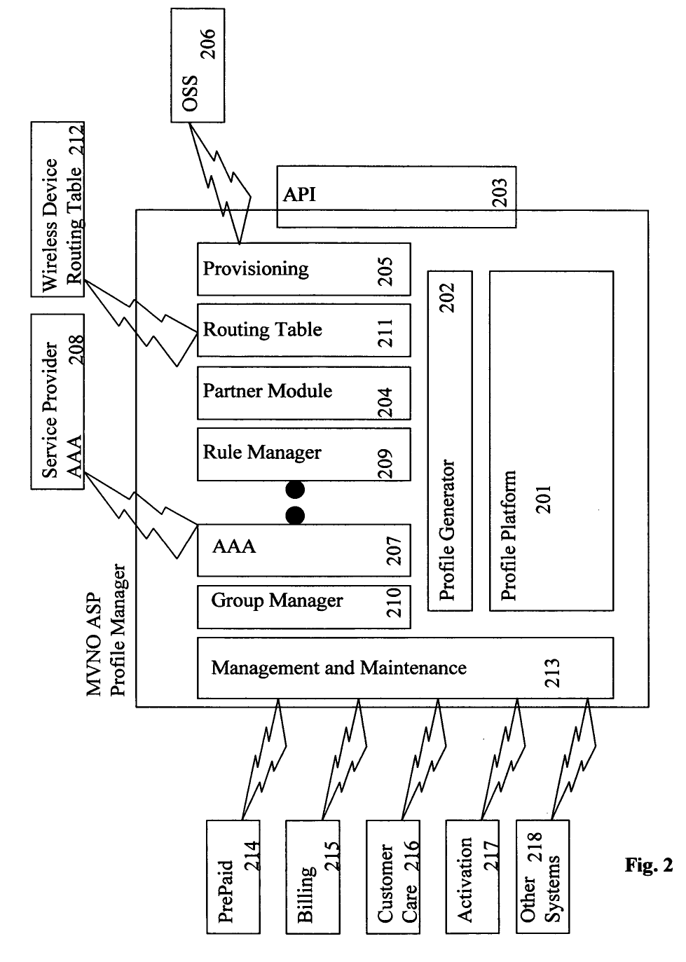

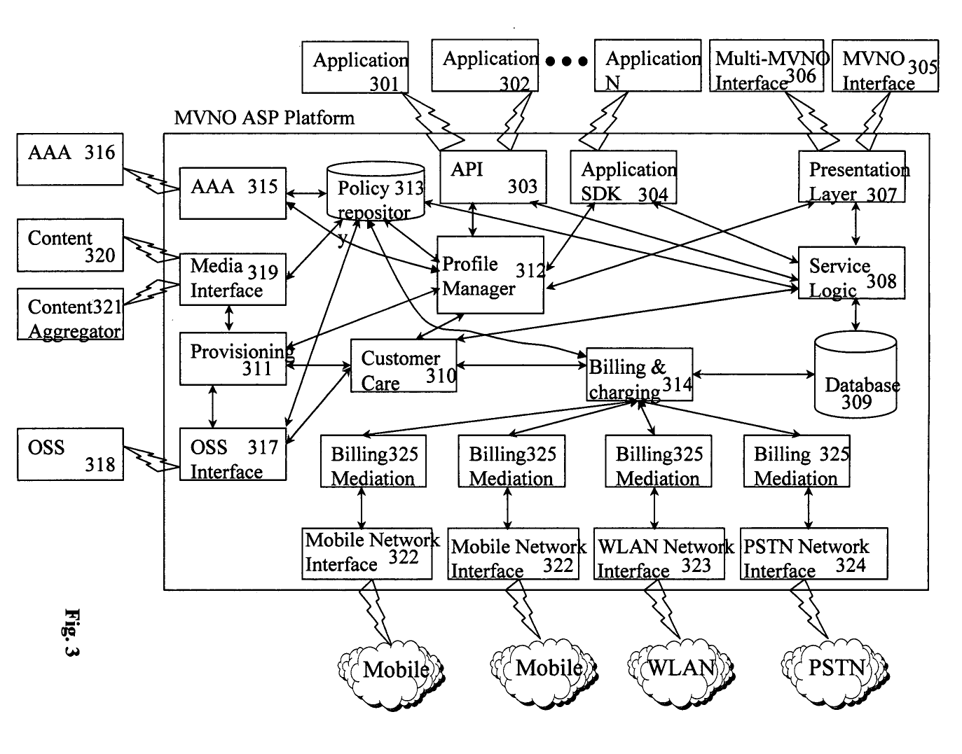

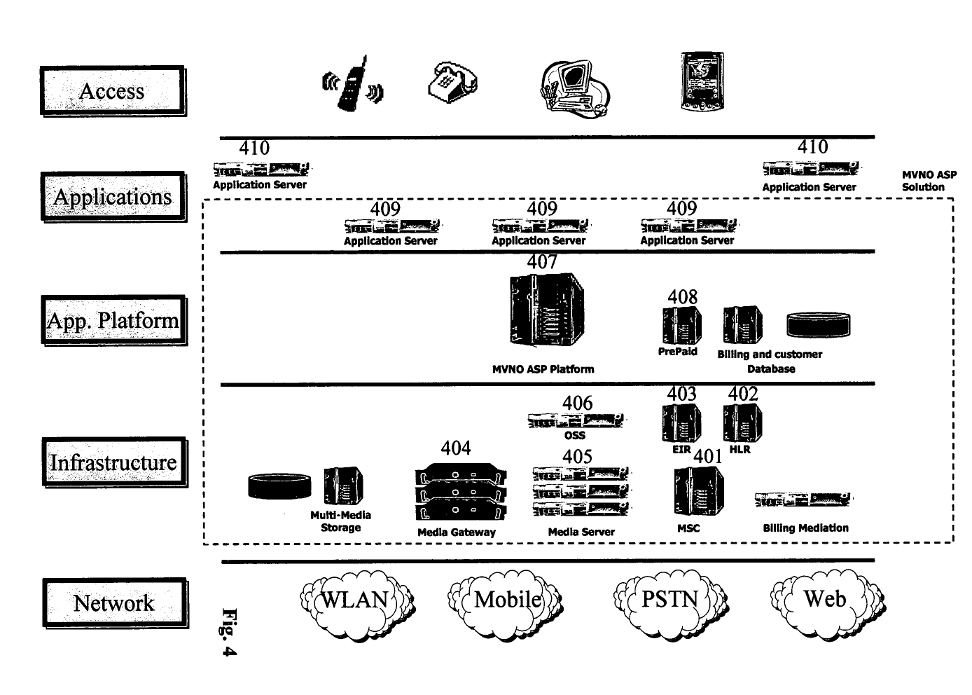

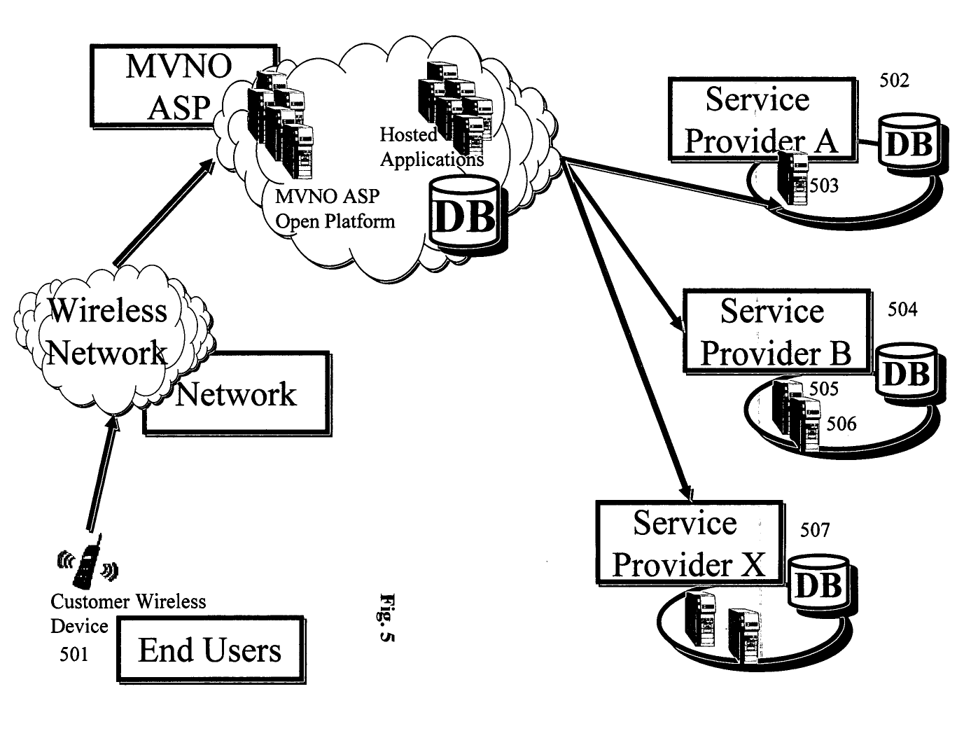

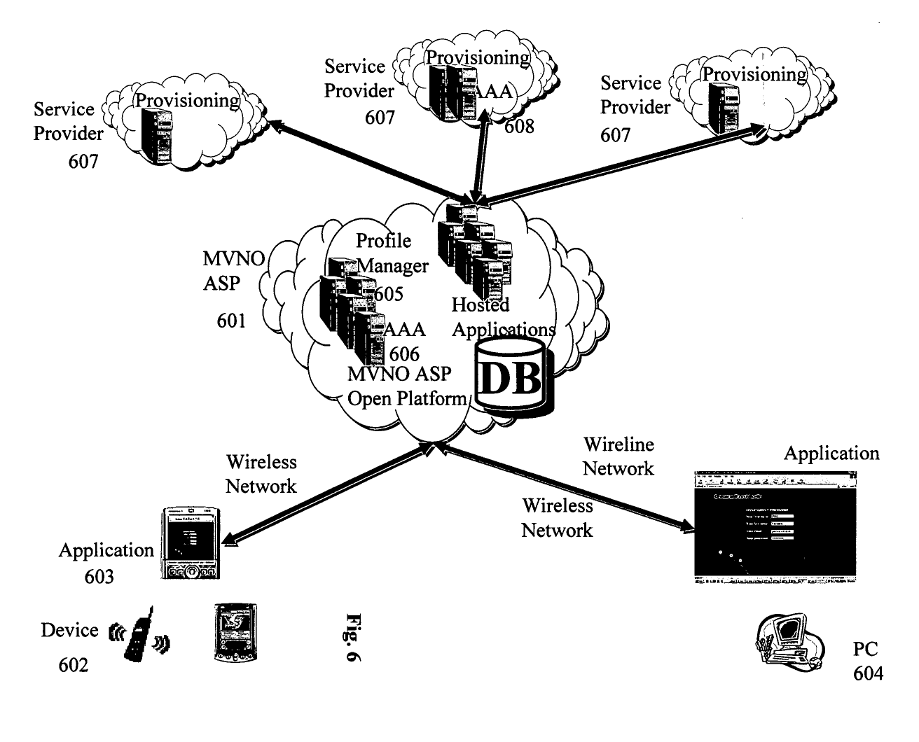

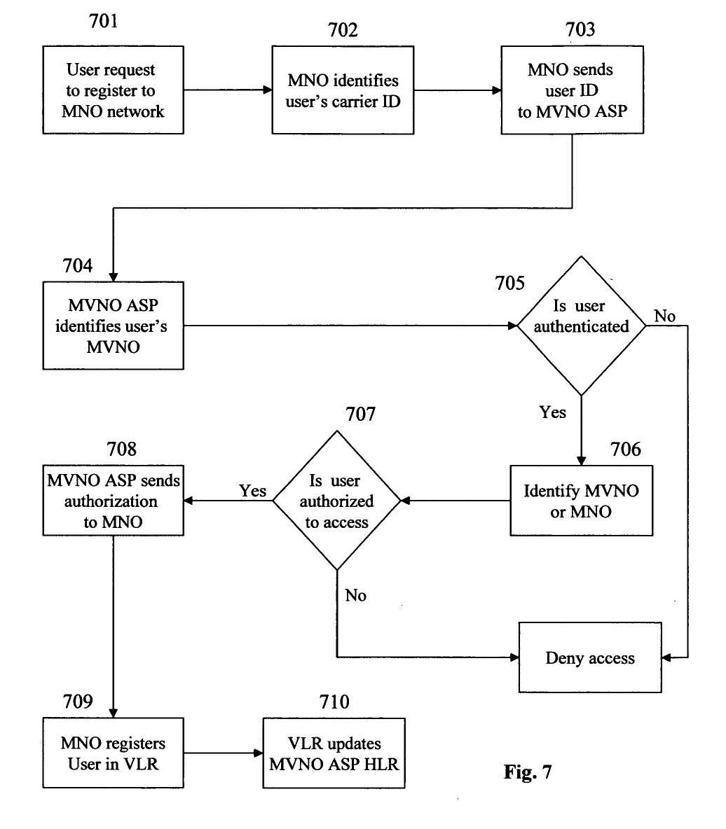

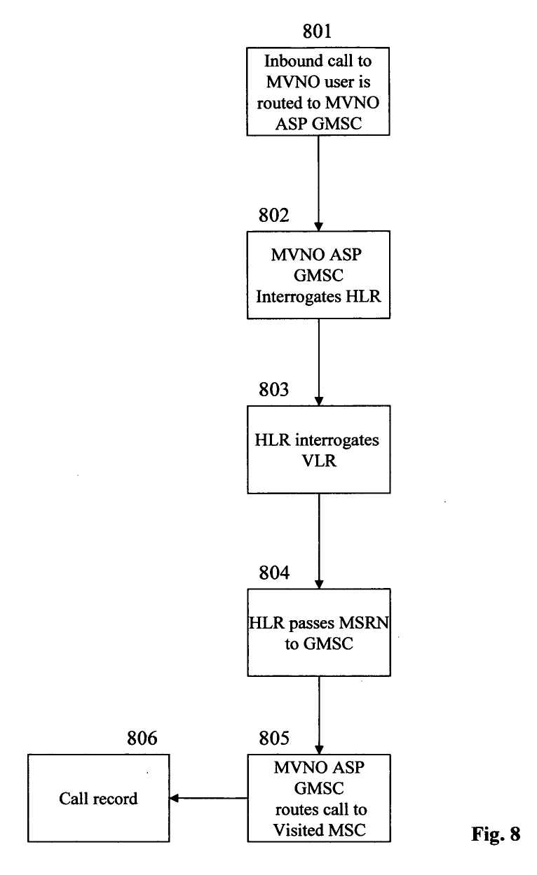

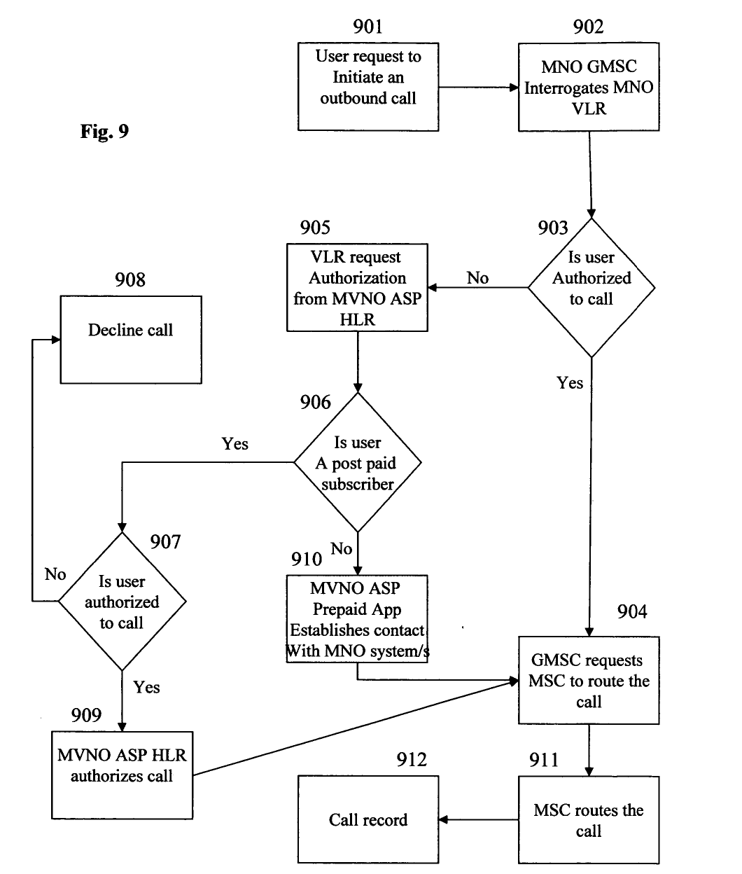

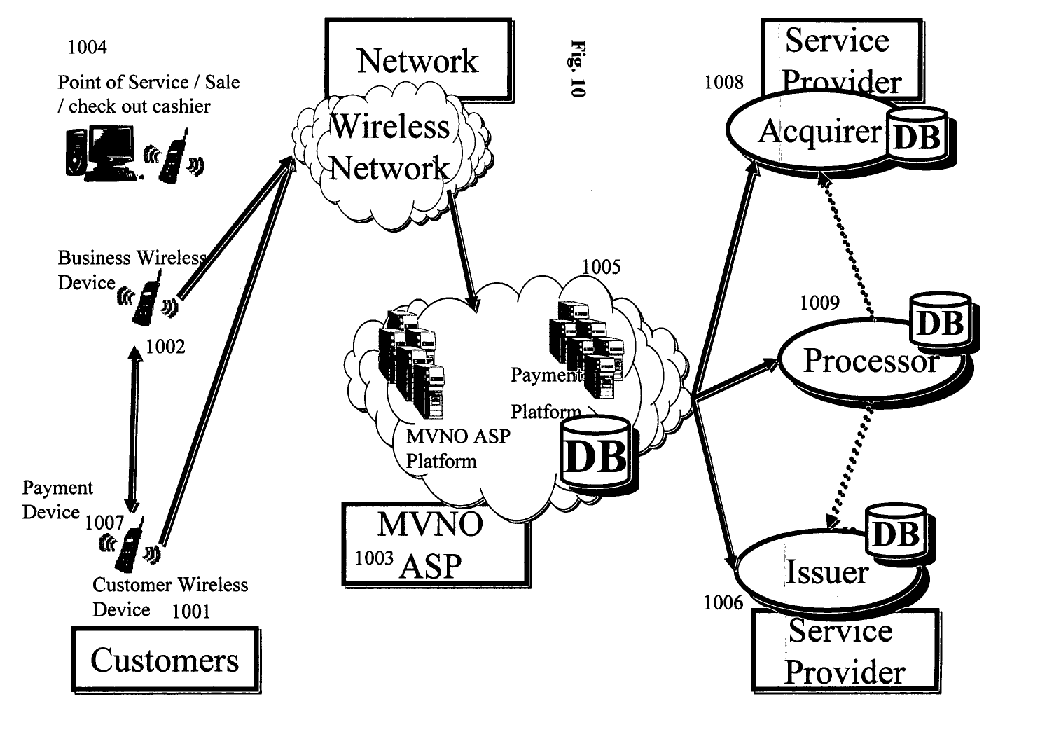

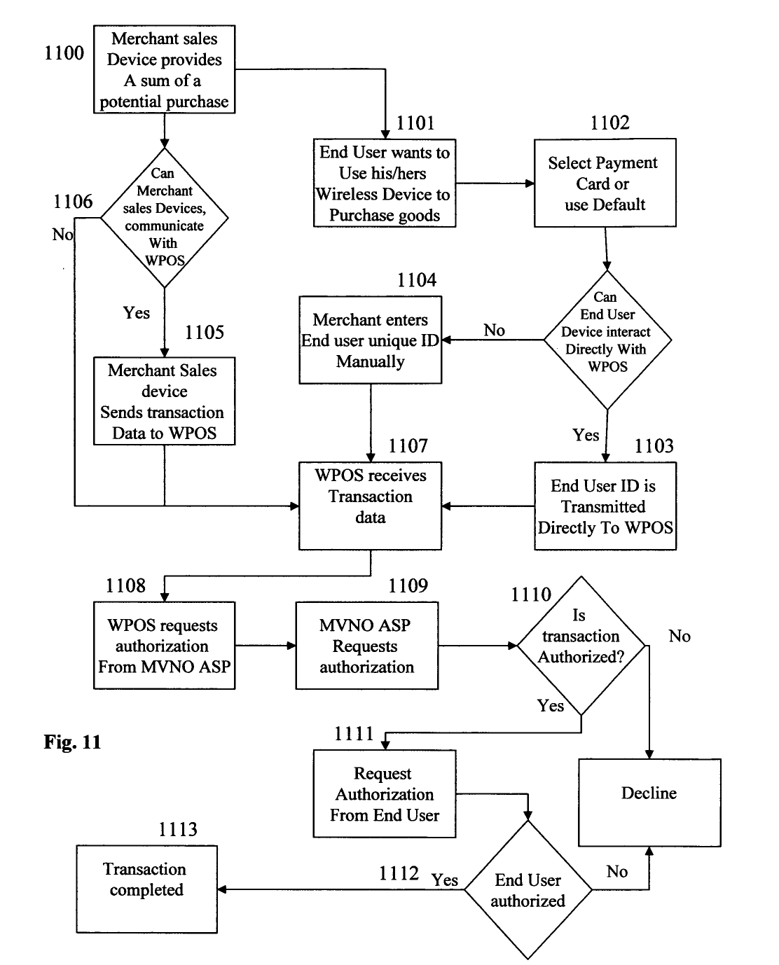

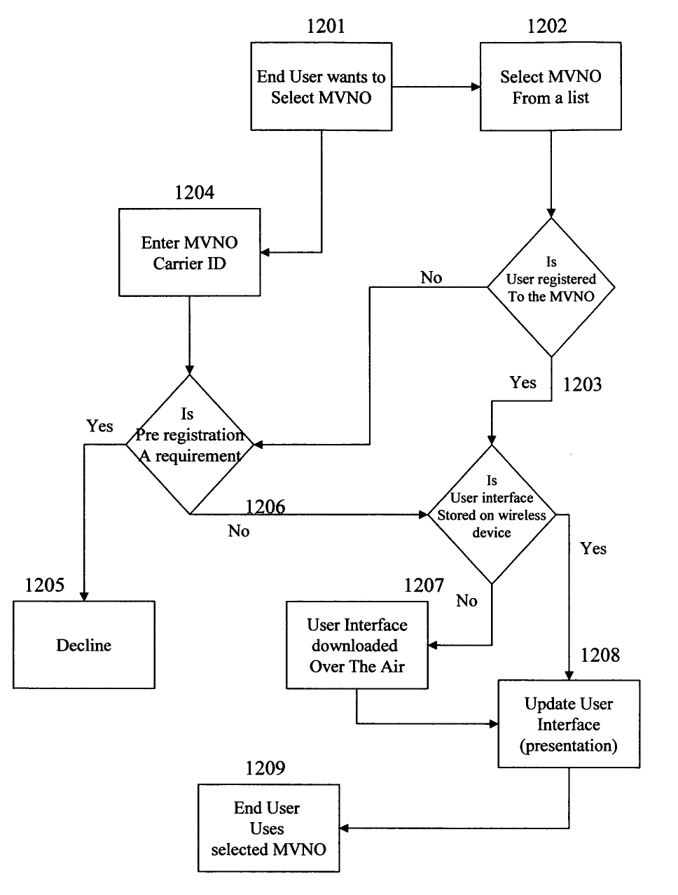

In FIG. 1 there is shown a block diagram illustration of one embodiment of the invention, in which a wireless device, which includes an application is described. The Wireless device includes an IC chip (101) and or a CPU, which can include a hardware component with personal data (102), such as a SIM card. The device has an operating system (103). The routing table (104) includes data regarding the Mobile Network Operators (MNOs), which are part of the MVNO ASP virtual wireless network. In addition the table includes various parameters (i.e. time of the day, default MNO) in order to select the MNO in cases where there is more then one MNO, in the same area, which are part of the MVNO ASP virtual network. The routing table is derived from the main Profile manager (see FIG. 2). In cases were wireless device is defined to always register to one default MNO, there will be no need for a routing table functionality.

The device includes an application platform (105), which is the infrastructure for adding applications to the wireless device. In some cases End Users will need to install service provider applications (106) in order to use their services. The device can include an additional authentication module (107) in order for the End User to enter a username and password or an additional hardware module (108) for additional identification such as biometric devices. The wireless device will include a management interface (109) enabling the End User to conduct tasks such as, change their configuration (if allowed), view reports and or enable the MVNO ASP and or the service provider to access their device for maintenance or management.

In FIG. 2 there is shown a block diagram illustration of one embodiment of the invention, in which a MVNO ASP Profile Manager is described. The Profile Manager is based on the profile platform (201), which includes a profile generator (202) enabling it to develop profile via a graphical interface and an API (203), so 3^{rd} party entities can access the profile manager. The rules and permissioning of the partner is defined in the partner module (204). The provisioning module (205) manages all the types of users permissions and integrates with external OSS (206) (can integrate with several OSS systems including MVNO ASP, service providers and network operator).

The Authentication, Authorization and Accounting server (AAA) (207) authenticates all users entering the system and authorizes them to use the services or limited services they can access, and is responsible for the accounting of these services. In some cases it interfaces with the service providers AAA system (208) in order to authenticate and or authorize End Users. The rule manager (209) enables the administrator/s to create rules for a specific user or for groups, which are set in the group manager (210). Based on the rule manager and the group manager the routing table generator (211) creates a routing table, which defines the MNO the End User device should automatically register to, based on the MNO being part of the MVNO ASP virtual network. In cases where there are more then one MNO in one area which are part of the MVNO ASP virtual network, additional parameters will be taken into consideration, such as: default MNO network, type of device, time of the day. This routing table is distributed to the End User Device (212) to enable the wireless device to register to the correct mobile network. The System has a management and maintenance module (213) enabling it to manage the system, create reports, alarms and other maintenance and management tasks.

The Profile Manager system integrates and or communicates with many systems such as Prepaid system (214) in order, for example, to provide the rules for disconnecting a service once the End User's account runs out of money (i.e. disconnect service, enable customer to charge their account in real time); Billing system (215); Customer Care (216); Activation (217) in order to activate End User account; and other systems (218).

In FIG. 3 there is shown a block diagram illustration of one embodiment of the invention, of a MVNO ASP Platform.

The MVNOs and or service providers can use pre-defined applications (301) or can develop or work with a developer or license and or rent and or purchase from a developer a new application (302). The application can be developed and interact with the MVNO ASP Platform via an API (303) or an application Service Development Kit (SDK) (304) which may include a graphical interface. The SDK can include testing debugging tools.

The service logic is stored and can be changed via the API or application SDK, the End User can manage and support his/her application via an MVNO interface (305) and the Multi MVNO Aggregator can manage and support its applications and MVNOs via a Multi MVNO interface (306), both interfaces are part of the presentation layer of the system (307). All applications business logic is stored in the service logic servers (308). All data is stored in the system database (309). The MVNO applications can be stored with the MVNO ASP or can be stored anywhere else and interact with the MVNO ASP Platform.

The system is fully partitioned enabling each MVNO and or service provider to set its own customers, set its own provisioning and permissioning, and manage and maintain its applications. The information is managed by the MVNO ASP via the customer care module (310) which maintains customer care information, which can include data such as, MVNO and or service provider information, billing plans, and data regarding each MVNO and or service provider customers; the provisioning of new users including new MVNO, new MVNO customers, new MVNO group customers and the services they can access are managed via the provisioning module (311) and the Profile Manager (312), see FIG. 2 for details.

In cases were the MVNO does not have a carrier ID and or is a software MVNO, the profile manager module includes a table, which maps each user to the MVNO it uses, enabling the MVNO ASP, to identify the MVNO that is providing service to a user. In these cases the MNO identifies the user as a MVNO ASP user, and the MVNO ASP is responsible for identifying the MVNO based on the above table.

The policy management and policy repository (313) are the focal point for authorizing users of the system access to resources, policy repository is built from data it retrieves from internal systems such as profile manager, charging module and external systems such as a mobile operator Operation Support System (OSS). Services such as, billing information, billing plans, charging, partner agreements order fulfillment and rating are gathered and maintained via the billing and charging module (314).

The Authentication Authorization Accounting system (AAA) (315) is the point of contact for authenticating, authorizing and accounting of users. It accesses modules such as the policy repository and the profile manager, and in some cases it will request external AAA systems (316) to provide the authentication and or authorization and or accounting (i.e. AAA system operated by the MVNO).

The system can interface (317) with external OSS (318) both for MVNO ASP operations and for the MVNOs and service providers OSS. Access to external content is managed via the media interface (319) and can be received via content provider (320) or content aggregator (321). The system interfaces with various networks such as, Mobile network (322) Wireless LAN (WLAN) (323) Public Switched Telephone Network (PSTN) (324), the system can interface with many networks from each type for example an MVNO ASP can interface with many mobile operators, each one can have its own agreement, with its own capacity, and pricing. The billing mediation module (325) collects the data from the various network interfaces and all data is aggregated by the billing module in order to enable payment to suppliers and creating bills for the MVNO and service providers and creating bills for the MVNO and service providers' customers.

In FIG. 4 there is shown an architecture diagram illustration of one embodiment of the invention, in which the MVNO ASP operation, includes switching capabilities. The MVNO ASP operates its own switch (401) Home Location Register (HLR) (402) EIR (403) and other communication servers such as Media Gateway (404) Media Servers (405) and operates its own OSS (406).

The MVNO ASP Platform (407) interacts with the MVNO ASP communication infrastructure as well as with other operator infrastructure.

The MVNO ASP can provide a prepaid solution (408), which will enable MVNO to offer such a service to their customers.

The MVNO ASP can provide core applications and standard applications (409) as part of the solution offered to MVNOs, applications such as, voice mail, unified messaging, SMS, conferencing etc.

Because the MVNO ASP Platform is an open system with standard and or documented interfaces, MVNOs, service providers and independent developers can create additional applications (410), these applications can be marketed and or operated by their creators and in some cases can become an additional application which is offered to all other MVNOs and service providers (most likely there will be a price tag for using the application).

In FIG. 5 there is shown an architecture diagram illustration of one embodiment of the invention, in which an End User uses several different service providers. The End User and their wireless device (501) were authenticated by the MVNO ASP, in this example, they are authorized to use service provider A's (502) m-commerce applications (503), and service provider B's (504) conference applications (505), but not its videoconference applications (506). When the End User wants to set-up a conference call, the following is a sample of methods they can select from (MVNO ASP may not provide all options): select from wireless device menu, IVR menu, voice command. The MVNO ASP platform will verify the End User's authorization to access this service and if this service is provided by more then one service provider the system will route the call to the default service provider unless the End User has set the system differently or selected a different service provider. The end User uses the application when finished the service billing data could be stored by Service Provider A or if service provider outsourced this service it will be stored with the outsourcer which will bill and collect the monies. The MVNO ASP stores the data needed in order to bill the service provider and pay the network operators, in some cases the MVNO ASP will be the service Provider's bill outsourcer too.

The End User can use a service from a service provider X (507) which he is not subscribed to by entering the service provider ID number (if the MVNO ASP did not block the End User's ability to use unassigned service providers). For example while walking in the street the End User sees a sign with a Supermarket commercial enabling them to receive a coupon by entering the Supermarket service provider ID number. The service provider can then ask the End User to add the supermarket as a permanent service provider enabling them to receive other discounts in real time while shopping in the supermarket. In some cases adding a new service provider to the End User's list will need additional authorizations such as a credit check by the service provider.

In FIG. 6 there is shown an architecture diagram illustration of one embodiment of the invention, in which an authentication process and customer configuration process is described. A MVNO ASP (601) stores in its database data regarding the End User's hardware device (602), for example, data could include SIM Card, type of device, MAC Number. In some cases an End User will enter a username and a password via the application (603) or an additional hardware module such as biometric device can be used. An End User can access the system from a computer (604) and then most likely will need to enter at least a username and a password. The MVNO ASP Profile Manager (605) and or AAA System (606) will require the End User to enter the required authentication. Once End User is authenticated the Profile Manager and or AAA will authorize the End User to access only the services they were provisioned. The MVNO ASP (601) manages the global End User settings, which may include rules such as, service providers which End User can access; End User ability to add new service providers; End User ability to change other End User's attributes (i.e. a corporate IT Manager managing there employees devices and configurations). Service Providers (607) can manage there own rules such as, which features an End User can access (i.e. End User can create a conference call with more then 3 participants). The MVNO ASP can store the service provider's rules and validate the rules via the AAA system and or Profile Manager and or the Service provider will have its own AAA (608) and it will manage, configure and authenticate End User's using its services.

In FIG. 7 there is shown a flow chart of one embodiment of the invention, of a mobile user network registration and authentication process of a multi MVNO user.

A user and or a device try to register to the Mobile Network Operator (MNO) network (701), the MNO is selected based on the wireless device routing table, the user and or device provide the MNO with user ID and or device ID (i.e. mobile subscriber identity number (MSIN) in a GSM network) and the carrier ID (i.e. Mobile Network Code (MNC) in a GSM network). The MNO identifies that the user and or device are not a MNO user and or device and identifies their carrier based on the carrier ID (702).

The MNO sends a request to the carrier which matches the carrier ID, to authenticate the user and or device (703) in this example the carrier ID matches the MVNO ASP carrier ID (i.e. in a GSM network, the MVNO ASP is the one issuing the SIM card).

The MVNO ASP identifies the user based on their User ID (704), if there is additional authentication requirements, such as password, the AAA system will manage the process. Once user is authenticated (705), the MVNO ASP identifies the MVNO associated with the End User for this case (706).

The AAA Server will look up if the user is authorized to register to the network and receive any limits or rules regarding the user (707). If user is authorized the MVNO ASP authorize the MNO to register the user, the authorization message can include any limitations or rules regarding the user (additional data will be sent based on the support of the MNO systems of these type of features) (708). MNO will register user to network and will register the user in its Visitor Location Register (VLR) (709). The VLR notifies the MVNO ASP HLR, which updates and or creates a record of the last VLR to update the position of the user (710).

In FIG. 8 there is shown a flow chart of one embodiment of the invention, of an inbound voice call to a multi MVNO mobile user, and a MVNO ASP which operates its own Mobile Switching Center (MSC), this example is based on a GSM network.

An inbound call is routed by the PSTN network using the PSTN number to the MVNO ASP Gateway Mobile Switching Center (GMSC) (801). The MVNO ASP GMSC then interrogates the MVNO ASP HLR (802) The MVNO ASP HLR has a translation table to convert the PSTN number to the International Mobile Station Identity (IMSI) number used by the GSM networks. The MVNO ASP HLR will have a record of the last VLR to update the position of the subscriber (or if the subscriber is attached to the network).

The MVNO ASP HLR interrogates the VLR (803), which responds with the Mobile Station Roaming Number (MSRN) for routing. That is the information needed by the MVNO ASP Gateway Mobile Switching Center (GMSC) to route the call. The MVNO ASP HLR then passes the MSRN to the MVNO ASP GMSC (804), which routes the call to the visited MSC (805) (in some cases the MVNO ASP GMSC will use the MSRN to route the call through the PSTN). The MVNO ASP keeps records of the call including call events, durations, the MNO network used, the MVNO that booked this call, and the MVNO ASP End user details (806), these records are then used for billing and settlement with partners and users.

In FIG. 9 there is shown a flow chart of one embodiment of the invention, of an outbound voice call from a multi MVNO mobile user, and a MVNO ASP which operates its own Mobile Switching Center (MSC), this example is based on a GSM network.

A MVNO ASP End User requests to initiate an outbound call (901). The MNO GMSC interrogates the MNO VLR (902). If MNO VLR authorized the subscriber (903) the GMSC requests to route the call (904).

If MNO VLR has no automatic authorization, it needs to contact the MVNO ASP HLR to request authorization (905). If the user is a MVNO post paid subscriber (906) the HLR will check if the user is authorized for such a call and are there any limits to such a call (907). In many cases the MVNO ASP HLR will be able to provide authorization, however in some cases the HLR will require the MVNO ASP Authentication Authorization and Accounting system (AAA) to provide the answer. If the user is not authorized a message will be sent to MNO to decline the call (908).

If the user is authorized the MVNO ASP HLR will authorize the call and provide the MNO GMSC with the authorization and any limitations on the call (based on the MNO support for such limits) (909).

If the user is a MVNO prepaid subscriber (906), then the MVNO ASP prepaid system will establish a connection with the MNO relevant system or systems (910) (depends on the MNO, it could be system such as the MNO prepaid system, MNO GMSC, MNO MSC), and then will authorize the call and will continue to monitor the call, for example it will request to disconnect the call if prepaid account is empty.

In both cases, prepaid and postpaid, the GMSC requests the MSC to route the call (904). The MVNO ASP can require to route the call via the MVNO ASP MSC, in cases the MVNO ASP does not request a special route the MNO will route the call based on its routing tables. Based on the GMSC request and instructions the MSC will route the call (911). The MVNO ASP keeps records of the call including call events, durations, the MNO network used, the MVNO that booked this call, and the MVNO ASP End user details (912), these records are then used for billing and settlement with partners and users.

In FIG. 10 there is shown an architecture diagram illustration of one embodiment of the invention, in which an End User purchases goods via their wireless device (1001) The End User wireless device interacts with the merchant Wireless Point of Sale (WPOS) (1002) and with the MVNO ASP (1003) systems. The WPOS can interact with the merchant back office and other merchant point of sales systems (1004) (i.e. cash register, point of service system), in most cases this interaction is in order payment amount.

The MVNO ASP develops partnerships with various network operators in order to create a virtual wireless offering. The MVNO ASP (1003) operates and maintains the MVNO ASP Payment Platform (1005), which manages the interaction regarding transactions with End Users, merchants, Issuers, Acquirers, Processors and any other person or entity involved in the purchase process.

The payment card Issuer (Issuer) (1006) is a service provider who issues the Payment Device (1007) for the End User, “owns” the customer relationship and is responsible for the credit and other customer related tasks related to their payment transactions.

The Acquirer (1008) is a service provider who enables the merchant to accept wireless and or regular payment cards. The Acquirer “owns” the merchant relationship and is responsible for the credit and other merchant related tasks.

A MVNO ASP communicates can communicate directly with issuers and acquirers in order to authorize a transaction and in this case will need to process settle and clear transactions, however the MVNO ASP can select to work with a processor (1009) which can take care of authorizing transactions, settling and clearing transactions between Issuer, Acquirer, End User and others; in this case the MVNO ASP will have one point of contact (processor) instead of dealing with many issuers and acquirers directly.

In FIG. 11 there is shown a flow chart diagram of one embodiment of the invention, in which an End User purchases goods via his/hers wireless device. An End User is interested in purchasing goods or services, the merchant creates the bill which sums the amount of money the End User should pay in order to purchase the goods and or service (1100). The End User selects to use his/hers wireless device (1101) to purchase the goods or service from a merchant. The End User selects the payment card that he/she would like to use or use the default payment card (1102). The End User Wireless Device interacts directly with merchant WPOS Device, saying he/she are interested in initiating a transaction and provides the End User unique ID (1103); the two devices can communicate using technologies such as, Infrared, Bluetooth, instant messaging, SMS, and or other methods. In cases that the devices cannot communicate directly, the merchant will need to enter a wireless End User unique ID manually (1104). The merchant WPOS receives the purchase data directly from the checkout cashier or any other point of sales/service device (1105), in cases there is not direct communications between both devices the merchant will enter the enters the purchase data into the WPOS Device directly (1106). Once the needed data regarding the pending transaction is received (1107), the data, which includes, End User ID, the transaction amount, the merchant ID are sent to the MVNO ASP payment application (1108). The MVNO ASP Payment application requests authorization for the transaction (1109) either directly with Issuer of the payment card or via a processor. Once transaction was authorized (1110) a message is sent to the End User to authorize the transaction (1111), once the End User authorizes the transaction (1112) a message is sent to the WPOS Device that transaction has been completed (1113). In addition messages are sent to Issuer and Acquirer (if MVNO ASP communicated with them directly, else it is sent to the Processor, which handled this transaction). At this stage Issuer, Acquirer and the processor (if relevant) have all information to process, settle and or clear the transaction in the same manner they will do if this was a regular transaction via their current payment systems.

In FIG. 12 there is shown a flow chart diagram of one embodiment of the invention, in which an End User selects the MVNO to use.

An End User is interested to select a MVNO (1201). Via the wireless device user interface the End User selects a MVNO (1202), the user interface can be a list of MVNOs presented via a browser, a speech recognition interface or any other interface. One of the options is select “other”, which is a MVNO who is not part of the list. If the End User is registered to the selected MVNO, then the End User can proceed and use this MVNO (1203). In some cases the MVNO is selected by entering a MVNO ID into an input field or via a voice interface (1204). When an End User selects a MVNO which they are not registered too, and a pre-registration is needed the End user will receive a decline message, which will include the needed procedure in order to signup to the service and contact information for support (1205). If no pre-registration is required then MVNO ASP will check if user interface for the selected MVNO is stored on wireless Device (1206). If it is not stored, the wireless device will download a user interface over the air (1207). The MVNO ASP provides a master user interface; based on the MVNO the End User has selected, the additional MVNO characteristics (i.e. skins, links, text, graphics), are integrated, creating a new or updated user interface (1208).

Once the user interface is updated to reflect the MVNO selected the End User will be able to start using the MVNO services (1209). The MVNO ASP is responsible for tracking which MVNO the End User is using and based on parameters, such as network events, and MVNO pricing for this End User, it is able to bill End Users for the usage of the various MVNOs network and service usage.

It will be appreciated that the invention is not limited to what has been shown and described hereinabove. Rather, the scope of the invention is limited solely by the claims that follow.

1. A method which enables Entity A to offer a mobile End User to use at least two Mobile Virtual Network Operators (MVNOs) and enabling an End User to move between MVNOs with no need to register again to the network while using one access device. Entity A (i.e. MVNO ASP) develops an agreement with at least one Mobile Network Operator (MNO) enabling Entity A to use the MNO network to provide a virtual network offering. Entity A enables a MVNO to provide mobile service using Entity A's virtual wireless network. A system comprising: An End User wireless device interface, a software system which manages End Users profiles; A software system to track events and track transfers between MVNOs.

2. A method according to claim 1 and further comprising, in which the End User accesses the mobile network from a set of devices which are provisioned in the system as devices the End User can use.

3. A method according to claim 1 and further comprising, in which the End User accesses the mobile network from devices which are not associated with this End User, by supplying the proper access codes and following the authentication and authorization processes.

4. A method according to claim 1 and further comprising, in which End Users define and manage their profiles.

5. A method according to claim 4 and further comprising, in which End Users set rules for switching between MVNOs and service providers.

6. A method according to claim 4 and further comprising, in which the End User sets default suppliers to provide specific services.

7. A method according to claim 1 and further comprising, in which the End User selects the providers of specific services in real time.

8. A method according to claim 7 and further comprising, in which the user interface is via voice.

9. A method according to claim 7 and further comprising, in which the user is presented with a list of providers to provide a specific service, and the End User selects the provider of the service from the list.

10. A method according to claim 7 and further comprising, in which the End User selects a provider for which the End User is not subscribed to their services.

11. A method according to claim 7 and further comprising, in which the End User selects provider by entering a code, which identifies the provider.

12. A method according to claim 1 and further comprising, in which End User groups are created and managed by Entity A.

13. A method according to claim 1 and further comprising, in which selected End Users create and manage groups of End Users.

14. A method according to claim 13 and further comprising, in which selected End Users enforces the group of users to use specific MVNOs and service providers.

15. A method according to claim 13 and further comprising, in which selected End Users develop rules for usage of specific MVNOs and service providers for the group of users.

16. A method according to claim 1 and further comprising, in which Entity A defines and manages a table of service providers and network operators that an End Customer can subscribe to.

17. A method according to claim 1 and further comprising, in which a service provider is an issuer of a payment card.

18. A method according to claim 1 and further comprising, in which a service provider is an acquirer of a payment card.

19. A method according to claim 1 and further comprising, in which the wireless device is used for purchasing goods.

20. A method and a system according to claim 19 and further comprising, in which a customer wireless device communicates with merchant wireless device and exchange data regarding a transaction.

21. A method and a system according to claim 19 and further comprising, in which a customer wireless device obtains merchant information via an input interface.

22. A method and a system according to claim 19 and further comprising, in which a customer inputs required transaction information manually via a software interface.

23. A method according to claim 19 and further comprising, in which Entity A operates a payment application platform, enabling it to authorize and decline transactions.

24. A method according to claim 23 and further comprising, in which Entity A receives potential transaction data from a merchant's wireless device; interact with merchant acquirer system; receive authorization message; and send transaction authorization message to merchant wireless device.

25. A method according to claim 23 and further comprising, in which Entity A receives potential transaction data from a merchant's wireless device; interacts with End User wireless device to receive additional transaction information; interact with merchant acquirer system; receive authorization message; and send transaction authorization message to merchant wireless device.

26. A method according to claim 23 and further comprising, in which Entity A receives potential transaction data from a merchant's wireless device; interact with a processor's system; receives authorization message from processor; and sends transaction authorization message to merchant wireless device.

27. A method according to claim 23 and further comprising, in which Entity A receives potential transaction data from a merchant's wireless device; interacts with End User wireless device to receive additional transaction information; interact with processor's system; receives authorization message from processor; and send transaction authorization message to merchant wireless device.

28. A method according to claim 23 and further comprising, in which a transaction number is sent via the wireless network to the customer wireless device and to the merchant payment device.

29. A method according to claim 1 and further comprising, in which Entity A provides service providers and MVNOs with settlement of the wireless network fees.

30. A method according to claim 1 and further comprising, in which Entity A provides service provider's users with a bill on behalf of service providers and under service provider's name.

31. A method according to claim 1 and further comprising, in which Entity A is a MVNO.

32. A method according to claim 1 and further comprising, in which Entity A is a MNO, and part of its virtual network is the MNO network.

33. A method according to claim 32 and further comprising, in which the network is based solely on the MNO network.

34. A system, which enables to define and manage End User profiles and parameters for switching between MVNOs; The System enables End Users which are registered to the network, to switch between MVNOs, without the need to disconnect from the network and register again; These MVNOs provide at least part of their service based on a virtual wireless network of Entity A. Entity A (i.e. MVNO ASP) develops an agreement with at least one Mobile Network Operator (MNO) enabling Entity A to use the MNO network to provide a virtual network offering. Entity A enables a MVNO to provide mobile service using Entity A's virtual wireless network. The system enables to define and manage End User profile and parameters for switching between service providers; and a software system to track events and track transfers between MVNOs and tracks transfers between SPs.

35. A system according to claim 34 and further comprising, in which the system manages the move between MVNOs and between service providers based on rules defined in the system.

36. A system according to claim 34 and further comprising, in which the system includes an End User interface to configure parameters and rules for switching between network operators and service providers.

37. A system, which manages wireless device user interfaces; the user interface includes a master interface which is part of the main portal and menus and is provided by Entity A. Entity A (i.e. MVNO ASP) develops an agreement with at least one Mobile Network Operator (MNO) enabling Entity A to use the MNO network to provide a virtual network offering. Entity A enables a MVNO to provide mobile service using Entity A's virtual wireless network. MVNOs which use Entity A virtual network define their user interface via the system, including skin and menus which will be plugged into the main Entity A portal, replacing Entity A skin and adding and replacing menus and ringtones based on the MVNO provisioning.

38. A system according to claim 37 and further comprising, in which a wireless device caches various MVNO interfaces, when the wireless device switches to use a different MVNO, it first check in its cache if the MVNO user interface is cached, if it is cached the wireless device will change the user interface based on the cached user interface.

39. A system according to claim 38 and further comprising, in which a wireless device identifies parts of user interface, which changed; and downloads over the wireless network only the changed data, and then presents an updated MVNO user interface

40. A system according to claim 37 and further comprising, in which the End User selects to use the MVNO interface and defines a link to enable them to switch to the master interface.

41. A system according to claim 37 and further comprising, in which the End User selects the parts of the master interface, which they want to be part of their main portal and can select the parts of the master interface, which they want to be part of other menus (i.e. master ringtone will not change when switching between MVNOs).

42. A system, which includes a master routing table comprising a list of the networks which create Entity A's virtual network, and per area the table defines a default network which End User's wireless devices should register to. The End User device stores the routing table locally and uses it in order to select to which network to register per location. Entity A (i.e. MVNO ASP) develops an agreement with at least one Mobile Network Operator (MNO) enabling Entity A to use the MNO network to provide a virtual network offering. Entity A enables a MVNO to provide mobile service using Entity A's virtual wireless network.

43. A system according to claim 42 and further comprising, in which the table includes additional parameters for deciding to which network to register in cases there are more then one network per area which belongs to Entity A virtual network.

44. A system according to claim 43 and further comprising, in which the time of the day is one of the parameters.

45. A system according to claim 43 and further comprising, in which the type of device is one of the parameters.
